(19) United States
(12) Patent Application Publication
(10) Pub. No.: US 2015/0205995 A1
(43) Pub. Date: Jul. 23, 2015

(54) PERSONAL RECOGNITION APPARATUS THAT PERFORMS PERSONAL RECOGNITION USING FACE DETECTING FUNCTION, PERSONAL RECOGNITION METHOD, AND STORAGE MEDIUM

(71) Applicant: CANON KABUSHIKI KAISHA, Tokyo (JP)

(72) Inventor: Satoshi Yamada, Kawasaki-shi (JP)

(21) Appl. No.: 14/600,054

(22) Filed: Jan. 20, 2015

(30) Foreign Application Priority Data
Jan. 23, 2014 (JP) 2014-010442

(51) Int. Cl. G06K 9/00

(52) U.S. Cl. CPC G06K 9/00228

(57) ABSTRACT

A personal recognition apparatus is disclosed which improves accuracy of personal recognition. A face region of a person included in a frame image is detected, and characteristic data is generated from the face region. For a plurality of persons, at least a piece of characteristic data for recognizing a person and a recognition history are stored for each of the characteristic data. Personal recognition is performed by comparing the generated characteristic data and stored characteristic data with each other and identifying a person having the generated characteristic data among the plurality of persons. The recognition history is updated based on a result of the personal recognition, and when data causing false recognition is included in the characteristic data stored for a predetermined individual, and the predetermined individual can be correctly recognized using other characteristic data, data is deleted or a priority of the data causing false recognition is lowered.

### BACKGROUND OF THE INVENTION

1. Field of the Invention

The present invention relates to a personal recognition apparatus, a personal recognition method, and a storage medium, and in particular to a personal recognition apparatus and a personal recognition method that perform personal recognition by detecting a face region of a person from image data, as well as a storage medium.

2. Description of the Related Art

A technique to perform personal recognition using a face detecting function is known. According to this technique, characteristic data in a face region is extracted from image data of a detected face, and the extracted characteristic data is compared with characteristic data registered in advance to determine whether or not the detected face is of a registered person. At this time, the accuracy of personal recognition can be improved by registering in advance not only a piece of characteristic data but also a plurality of characteristic data with different head poses and facial expressions for each individual.

However, if characteristic data that causes false recognition (false recognition causing data) is included in a plurality of registered characteristic data, the probability of correctly recognizing the person (correct acceptance rate) increases, and on the other hand, the probability of not falsely recognizing the other person (correct rejection rate) decreases. As a result, the overall accuracy of personal recognition may decrease. It should be noted that characteristic data that causes false recognition means characteristic data likely to cause another person other than a person to be falsely recognized.

Techniques to circumvent this problem are described in, for example, Japanese Laid-Open Patent Publication (Kokai) Nos. 2007-213126 and 2007-179224. According to the technique described in Japanese Laid-Open Patent Publication (Kokai) No. 2007-213126, characteristic data and the number of previous successful personal recognitions and the number of mistakes using the characteristic data are held as histories in a personal database. Based on the held histories, whether or not there is any characteristic data for which the number of mistakes is large and which causes false recognition is determined, and the characteristic data that causes false recognition is deleted from the personal database.

According to the technique described in Japanese Laid-Open Patent Publication (Kokai) No. 2007-179224, a plurality of face images is extracted and held as a face image group while an individual to be recognized is being shot, one face image is selected as a reference face image from the held face image group, and in the held face image group, the degrees of similarity between the reference face image and other face images are obtained. Then, for example, three face images of which similarities are a maximum value, a minimum value, and an intermediate value and information on their characteristic amounts are registered in a personal database.

According to the technique described in Japanese Laid-Open Patent Publication (Kokai) No. 2007-213126, however, the correct acceptance rate increases due to a decrease in characteristic data that causes false recognition, but when a person cannot be correctly recognized unless held characteristic data is used, the correct acceptance rate decreases. As a result, the accuracy of personal recognition cannot be improved as a whole.

Also, according to the technique described in Japanese Laid-Open Patent Publication (Kokai) No. 2007-179224, when a plurality of individuals is registered, the accuracy of personal recognition may not be improved. For example, assume that characteristic data based on a face image of a face turned sideways is registered for an individual A, but no characteristic data based on a face image of a face turned sideways is registered for an individual B. In this case, when recognition is performed with the individual B turned sideways, the individual B is not recognized as the individual B because no characteristic data of the face turned sideways is registered for the individual B, and on the other hand, may be recognized as the individual A for whom characteristic data of the face turned sideways is registered.

### SUMMARY OF THE INVENTION

The present invention provides a personal recognition apparatus and a personal recognition method which are capable of improving the accuracy of personal recognition, as well as a storage medium.

Accordingly, a first aspect of the present invention provides a personal recognition apparatus that performs personal recognition using an image, comprising a detection unit configured to detect a face region of a person included in a frame image that has been input, a generation unit configured to generate characteristic data from the face region detected by the detection unit, a storage unit configured to, for a plurality of persons, hold at least a piece of characteristic data for recognizing a person and a recognition history with respect to each of the characteristic data, a recognition unit configured to perform personal recognition by comparing the characteristic data generated by the generation unit and the characteristic data stored in the storage unit with each other and identifying a person having the characteristic data generated by the generation unit among the plurality of persons stored in the storage unit, and an update unit configured to update the recognition history stored in the storage unit based on a result of the personal recognition performed by the recognition unit, and when false recognition causing data that causes false recognition is included in the characteristic data stored in the storage unit with respect to a predetermined individual, and the predetermined individual can be correctly recognized using other characteristic data, delete the false recognition causing data from the storage unit or lower a priority of the false recognition causing data.

Accordingly, a second aspect of the present invention provides a personal recognition apparatus that performs personal recognition using an image, comprising a detection unit configured to detect a face region of a person included in a frame image that has been input, a generation unit configured to generate characteristic data from the face region detected by the detection unit, a storage unit configured to, for a plurality of persons, hold at least a piece of characteristic data for recognizing a person and the number of mistakes in which the other person has been falsely recognized with the characteristic data, a recognition unit configured to perform personal recognition by comparing the characteristic data generated by the generation unit and the characteristic data stored in the storage unit with each other and identifying a person having the characteristic data generated by the generation unit among the plurality of persons stored in the storage unit, and an update unit configured to update the number of mistakes based on a result of the personal recognition, a first proposal unit configured to propose additional registration of predetermined characteristic data to the characteristic data stored in the storage unit with respect to a predetermined individual, and a second proposal unit configured to, when characteristic data with which the number of mistakes is equal to or greater than a fourth threshold value is present in a plurality of pieces of characteristic data stored in the storage unit with respect to the predetermined individual after the number of mistakes is updated by the update unit, propose additional registration of characteristic data similar to the characteristic data for which the number of mistakes is equal to or greater than the fourth threshold value to characteristic data on the other person.

Accordingly, a third aspect of the present invention provides a personal recognition method implemented by a personal recognition apparatus that has a storage unit and performs personal recognition using an image, comprising a detection step of detecting a face region of a person included in a frame image that has been input, a generation step of generating characteristic data from the face region detected in the detection step, a recognition step of performing personal recognition by comparing the characteristic data generated in the generation step and the characteristic data stored in the storage unit with respect to a plurality of persons so as to recognize persons with each other and identifying a person having the characteristic data generated in the generation step among the plurality of persons stored in the storage unit, and an update step of updating a recognition history stored in the storage unit based on a result of the personal recognition performed in the recognition step, and a changing step of, when false recognition causing data that causes false recognition is included in the characteristic data stored in the storage unit with respect to a predetermined individual, and the predetermined individual can be correctly recognized using other characteristic data, deleting the false recognition causing data from the storage unit or lowering a priority of the false recognition causing data.

Accordingly, a fourth aspect of the present invention provides a personal recognition method implemented by a personal recognition apparatus that has a storage unit and performs personal recognition using an image, comprising a detection step of detecting a face region of a person included in a frame image that has been input, a generation step of generating characteristic data from the face region detected in the detection step, a recognition step of performing personal recognition by comparing the characteristic data generated in the generation step and the characteristic data stored in the storage unit with respect to a plurality of persons so as to recognize persons with each other and identifying a person having the characteristic data generated in the generation step among the plurality of persons stored in the storage unit, a storage step of, based on a result of the personal recognition, storing the number of mistakes, in which the other person is falsely recognized with the characteristic data stored in the storage unit, in an accumulated manner, and a proposal step of, when characteristic data for which the number of mistakes is equal to or greater than a fourth threshold value is present in a plurality of pieces of characteristic data stored in the storage unit with respect to a predetermined individual, proposing additional registration of characteristic data similar to the characteristic data for which the number of mistakes is equal to or greater than the fourth threshold value to characteristic data on the other person.

Accordingly, a fifth aspect of the present invention provides a non-transitory computer-readable storage medium storing a program for causing a computer to implement a personal recognition method for a personal recognition apparatus that has a storage unit and performs personal recognition using an image, the personal recognition method comprising a detection step of detecting a face region of a person included in a frame image that has been input, a generation step of generating characteristic data from the face region detected in the detection step, a recognition step of performing personal recognition by comparing the characteristic data generated in the generation step and the characteristic data stored in the storage unit with respect to a plurality of persons so as to recognize persons with each other and identifying a person having the characteristic data generated in the generation step among the plurality of persons stored in the storage unit, and an update step of updating a recognition history stored in the storage unit based on a result of the personal recognition performed in the recognition step, and a changing step of, when false recognition causing data that causes false recognition is included in the characteristic data stored in the storage unit with respect to a predetermined individual, and the predetermined individual can be correctly recognized using other characteristic data, deleting the false recognition causing data from the storage unit or lowering a priority of the false recognition causing data.

Accordingly, a sixth aspect of the present invention provides a non-transitory computer-readable storage medium storing a program for causing a computer to implement a personal recognition method for a personal recognition apparatus that has a storage unit and performs personal recognition using an image, the personal recognition method comprising a detection step of detecting a face region of a person included in a frame image that has been input, a generation step of generating characteristic data from the face region detected in the detection step, a recognition step of performing personal recognition by comparing the characteristic data generated in the generation step and the characteristic data stored in the storage unit with respect to a plurality of persons so as to recognize persons with each other and identifying a person having the characteristic data generated in the generation step among the plurality of persons stored in the storage unit, a storage step of, based on a result of the personal recognition, storing the number of mistakes, in which the other person is falsely recognized with the characteristic data stored in the storage unit, in an accumulated manner, and a proposal step of, when characteristic data for which the number of mistakes is equal to or greater than a fourth threshold value is present in a plurality of pieces of characteristic data stored in the storage unit with respect to a predetermined individual, proposing additional registration of characteristic data similar to the characteristic data for which the number of mistakes is equal to or greater than the fourth threshold value to characteristic data on the other person.

According to the present invention, when characteristic data that causes false recognition in personal recognition is included in a plurality of characteristic data registered for a particular individual, the characteristic data that causes false recognition is deleted in a case where the particular individual can be correctly recognized using only other characteristic data. As a result, the correct rejection rate is increased without bringing about a decrease in the correct acceptance rate, and the accuracy of personal recognition is improved.

Moreover, according to the present invention, characteristic data having the characteristics as those of characteristic data on the other person who has been falsely recognized is additionally registered as characteristic data on an individual who has not been recognized as genuine due to false recognition. As a result, the correct rejection rate is increased without bringing about a decrease in the correct acceptance rate, and the accuracy of personal recognition is improved.

Further features of the present invention will become apparent from the following description of exemplary embodiments (with reference to the attached drawings).

### BRIEF DESCRIPTION OF THE DRAWINGS

FIG. 1 is a block diagram showing a general arrangement of a personal recognition apparatus according to embodiments of the present invention.

FIG. 2 is a flowchart showing an overall process carried out by the personal recognition apparatus in FIG. 1.

FIG. 3 is a flowchart showing in detail how a personal database is updated in step S209 in FIG. 2.

FIGS. 4A to 4C are views showing exemplary recognition result statistical information on characteristic data for personal recognition registered in the personal database which the personal recognition apparatus in FIG. 1 has, in which FIG. 4A shows data before update, FIG. 4B shows data after a process in step S307 in FIG. 3, and FIG. 4C shows data after a process in step S310 in FIG. 3.

FIGS. 5A to 5C are views showing concrete examples of characteristic data for personal recognition registered in the personal database which the personal recognition apparatus in FIG. 1 has.

FIG. 6 is a schematic diagram useful in explaining a face tracking process in step S206 in FIG. 2.

FIG. 7A is a diagram showing results of personal recognition in respective frames in a case where a face of a certain person is detected in five successive frames through personal recognition performed by the personal recognition apparatus in FIG. 1, and FIG. 7B is a diagram showing recognition results for persons updated based on the results of personal recognition in FIG. 7A.

FIG. 8 is a flowchart showing in detail how a personal database is updated in step S209 according to a fourth embodiment.

FIGS. 9A and 9B are views showing exemplary false recognition history information prepared so as to implement the fourth embodiment, in which FIG. 9A shows data before update, and FIG. 9B shows data after a process in step S804 in FIG. 8.

FIGS. 10A and 10B are views showing exemplary views that prompt a user to additionally register characteristic data to the personal database in step S806 in FIG. 8.

### DESCRIPTION OF THE EMBODIMENTS

The present invention will now be described in detail with reference to the drawings showing embodiments thereof.

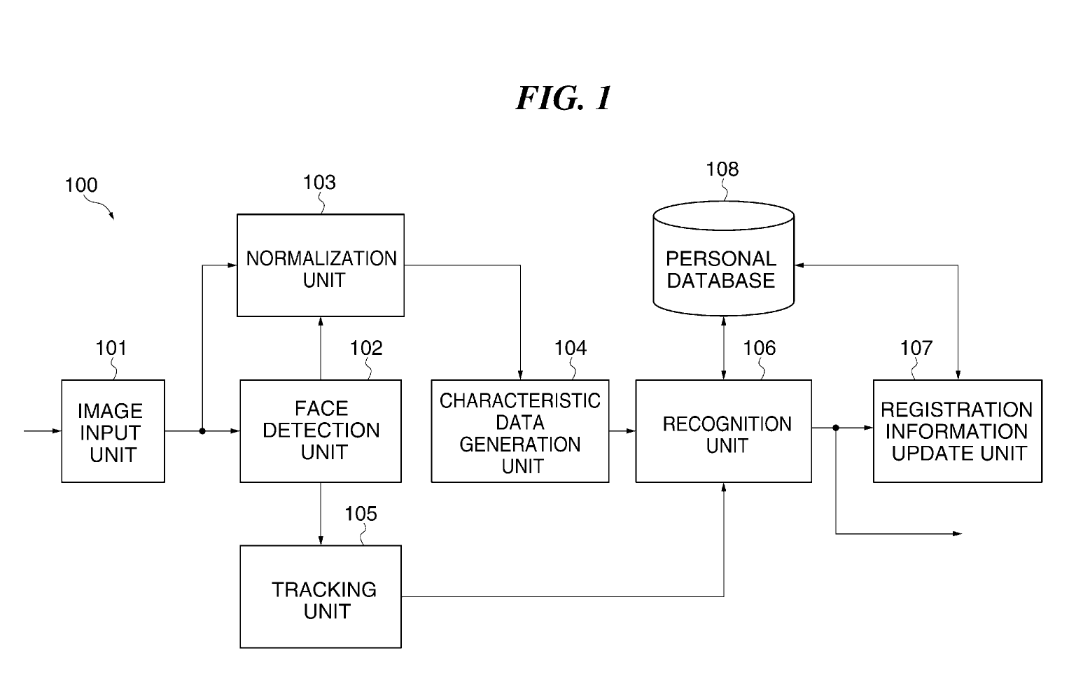

FIG. 1 is a block diagram showing a general arrangement of a personal recognition apparatus 100 according to embodiments of the present invention. It should be noted that the general arrangement of the personal recognition apparatus 100 in FIG. 1 is common to second to fifth embodiments, to be described later, as well as a first embodiment.

The personal recognition apparatus 100 has an image input unit 101, a face detection unit 102, a normalization unit 103, a characteristic data generation unit 104, a tracking unit 105, a recognition unit 106, a registration information update unit 107, and a personal database 108.

The image input unit 101 converts an optical subject image obtained through a taking lens, not shown, into an analog electric signal using an image pickup device such as a CMOS sensor or a CCD sensor and performs analog-to-digital conversion of the analog electric signal output from the image pickup device to generate digital image data (hereafter referred to as “image data”). The image data thus generated by the image input unit 101 is sent to the face detection unit 102 and the normalization unit 103.

The face detection unit 102 detects a position and size of a face region of a person from the input image data. It should be noted that a method to detect a face is not particularly limited, and a well-known method can be used. For example, the face detection unit 102 extracts from the input image data shapes corresponding to constituent elements of the face region such as a nose, a mouth, and eyes and detects a region where there are a nose and a mouth on an extension passing between both eyes. The face detection unit 102 then estimates a facial size based on the size of both eyes and the distance between them and assumes a region enclosed by a region of the estimated size as a face region using a position corresponding to the center of the nose as a reference. Information on the face region detected by the face detection unit 102 is sent to the normalization unit 103 and the tracking unit 105.

Based on the information on the face region obtained from the face detection unit 102, the normalization unit 103 clips a face region from the image data obtained from the image input unit 101, and when the clipped face is tilted, the normalization unit 103 performs a rotation process so as to correct the tilt. By enlarging or reducing the face region to a predetermined size so that the distance between both eyes can be a predetermined distance, the normalization unit 103 normalizes the face region to face image data with a predetermined angle and size. The normalized face image data generated by the normalization unit 103 is sent to the characteristic data generation unit 104.

The characteristic data generation unit 104 extracts characteristic data from the normalized face image data. As disclosed in, for example, Japanese Laid-Open Patent Publication (Kokai) No. 2005-266981, the characteristic data includes information on concrete shapes of constituent elements of a face such as a mouth, eyes, eyebrows, and a nose and positions of these constituent elements. It should be noted that the characteristic data can be extracted from the input face image data by performing computations using a method such as edge detection using a neural network, a spatial filter, and so on. Here, the characteristic data may include not only information on shapes and positions of constituent elements but also information on color saturations and hues. The characteristic data generated by the characteristic data generation unit 104 is sent to the recognition unit 106.

For a face region detected in a certain frame in image data including a plurality of frames such as video, the tracking unit 105 determines which region in another frame is a face region of the same person. Specifically, when a plurality of faces is detected from image data in a certain frame, and one or a plurality of faces is detected from image data in another frame as well, the tracking unit 105 regards faces similar in size and position as faces of the same person. Also, when no face region similar to a face region detected in a certain frame is detected in another frame, the tracking unit 105 retrieves a region similar in brightness and color-difference pattern to the detected face region from a region around the other frame and tracks it.

The recognition unit 106 performs personal recognition by comparing and collating characteristic data for personal recognition registered in the personal database 108 with respect to a plurality of persons with characteristic data on a face region extracted by the characteristic data generation unit 104. Characteristic data for use in personal recognition is registered in the personal database 108, and based on results of personal recognition performed by the recognition unit 106, the registration information update unit 107 updates recognition result statistical information on the characteristic data registered in the personal database 108. It should be noted that the recognition result statistical information shows results of previous personal recognition using the characteristic data registered in the personal database 108.

Based on the recognition result statistical information, the registration information update unit 107 determines whether or not there is unnecessary characteristic data in characteristic data and deletes the unnecessary characteristic data from the personal database 108 to update characteristic data registered in the personal database 108. A detailed description will be given later of how the personal database 108 is updated by the registration information update unit 107.

The personal recognition apparatus 100 arranged as described above may be comprised of a single apparatus or may be configured as a system comprised of a plurality of apparatuses. For example, the personal recognition apparatus 100 may be constructed by providing all the constituent elements from the image input unit 101 to the personal database 108 inside a single image pickup apparatus such as a digital camera or a digital video camera. On the other hand, the personal recognition apparatus 100 may be constructed by providing an image pickup apparatus with only the image input unit 101 and providing an external apparatus such as a computer capable of communicating with the image pickup apparatus with the constituent elements other than the image input unit 101. Alternatively, the personal recognition apparatus 100 may be constructed by allotting all the constituent elements from the image input unit 101 to the personal database 108 among a plurality of computers on a network and carrying out data communications among the plurality of computers.

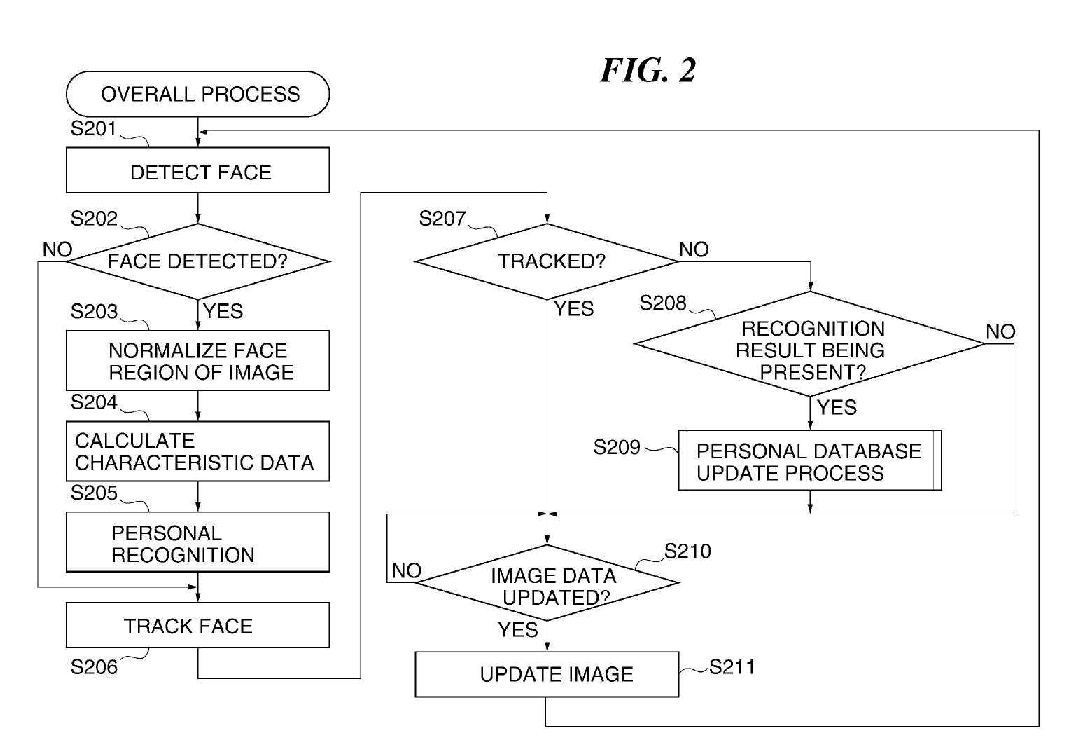

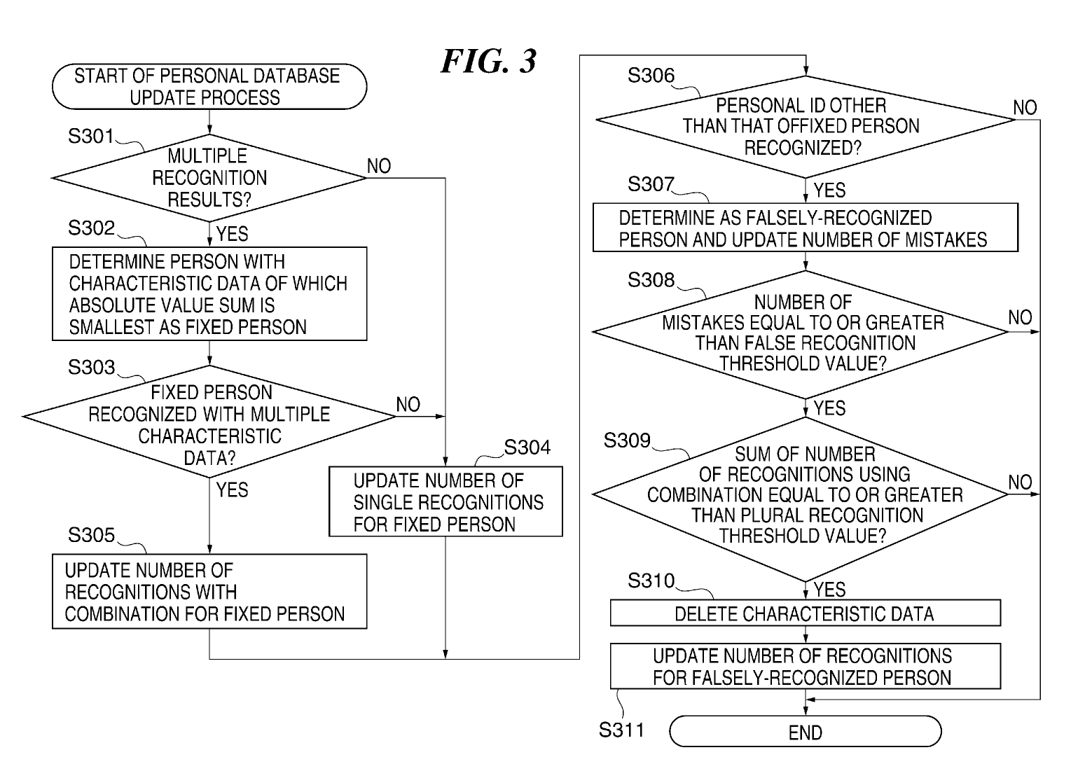

The flow of a personal recognition process carried out by the personal recognition apparatus 100 will be described with reference to FIGS. 2 and 3, but before that, a description will be given of, for example, characteristic data for personal recognition registered in the personal database 108.

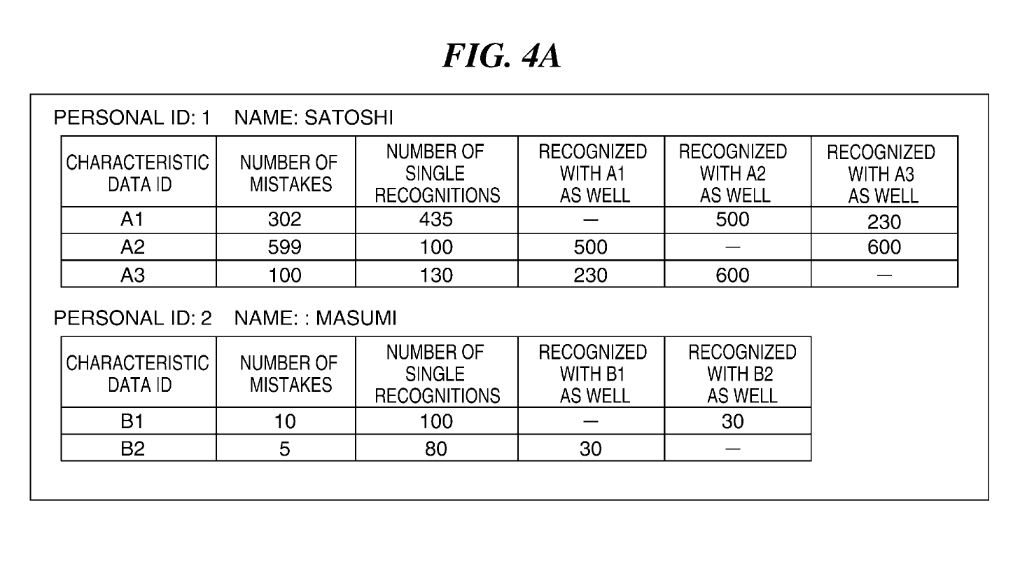

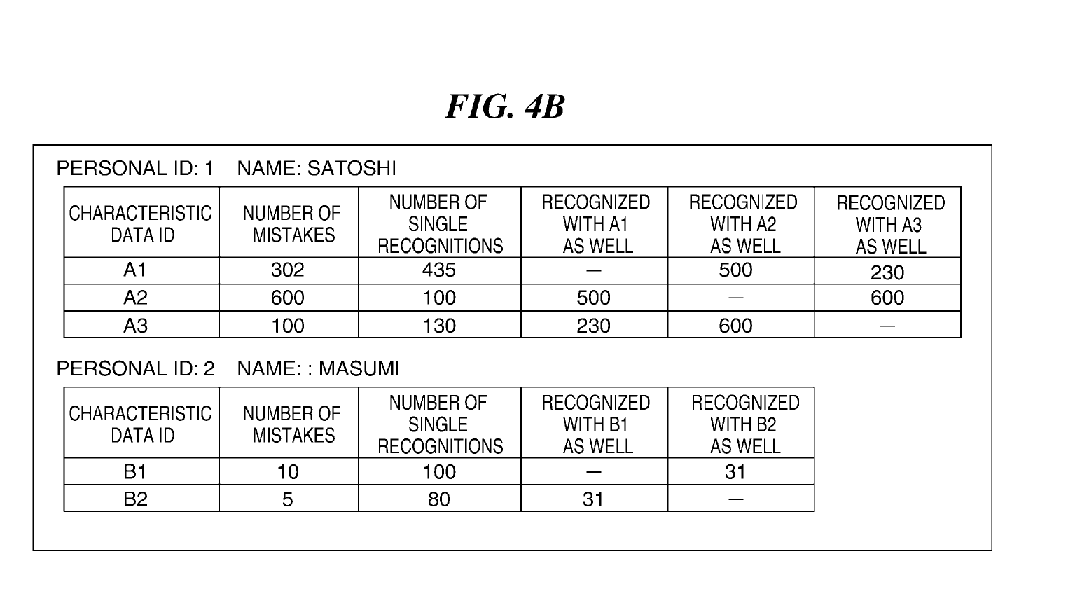

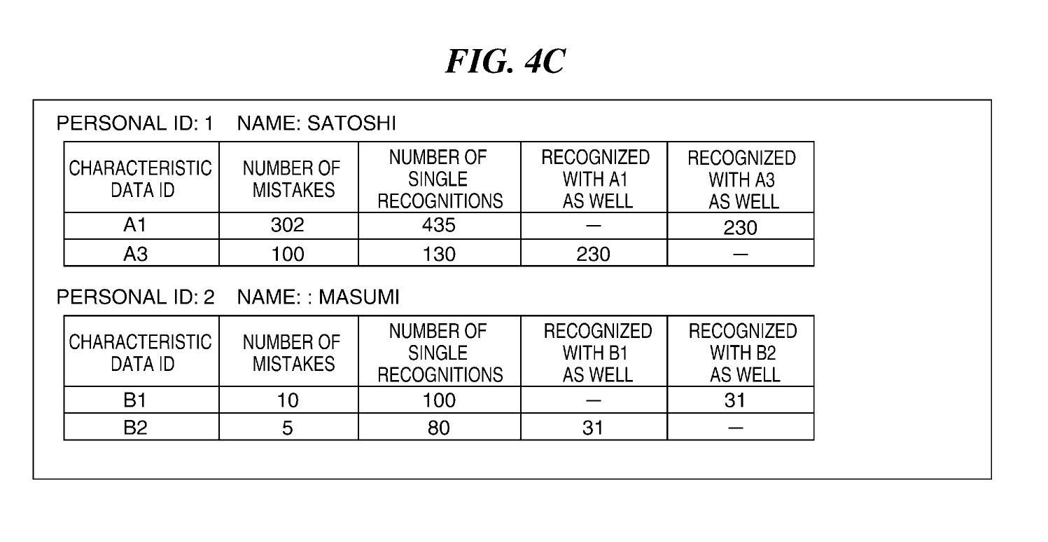

FIGS. 4A to 4C are views showing exemplary recognition result statistical information on characteristic data for personal recognition registered in the personal database 108. It should be noted that here, FIG. 4A shows data before update by the registration information update unit 107, FIG. 4B shows data after a process in step S307 in FIG. 3, to be described later, and FIG. 4C shows data after a process in step S310 in FIG. 3, to be described later.

In the first embodiment, personal IDs are assigned to registered individuals, and characteristic data IDs are assigned to respective characteristic data registered for each individual so that a plurality of characteristic data can be registered for each individual. In the example shown in FIG. 4A, a personal ID “1” is assigned to an individual named “Satoshi”, and three different characteristic data to which characteristic data IDs “A1”, “A2”, and “A3” are assigned are registered for this individual. Also, a personal ID “2” is assigned to an individual named “Masumi”, and two different characteristic data to which characteristic data IDs “B1” and “B2” are assigned are registered for this individual.

Recognition histories for respective characteristic data are managed based on recognition result statistical information. As recognition histories, the number of mistakes (the number of false recognitions) is stored as a result of recognition performed using each characteristic data with respect to each registered characteristic data ID. For example, the number of mistakes “302” for characteristic data with the characteristic data ID=A1 of “Satoshi” indicates that “Satoshi” has been falsely recognized 302 times based on characteristic data with the characteristic data ID=A1 although “Masumi” is a correct recognition target.

As recognition histories, the number of successful recognitions (the number of correct recognitions) is stored as a result of recognition performed using each registered characteristic data with respect to each registered characteristic data. The number of successful recognitions includes the number of times recognition is successful using only single characteristic data (the number of single recognitions) and the number of recognitions in a case where recognition is successful using a combination of characteristic data in a case where recognition using other characteristic data at the same time is successful (for example, recognition with A1 as well or recognition with A2 as well).

For example, “the number of single recognitions” being “435” for characteristic data with the characteristic data ID=A1 of “Satoshi” indicates that “Satoshi” has been correctly recognized 435 times only with characteristic data with the characteristic data ID=A1 in a case where “Satoshi” is a correct recognition target.

Also, “recognized with A2 as well” being “500” for characteristic data with the characteristic data ID=A1 of “Satoshi” indicates that the number of times “Satoshi” has been correctly recognized using characteristic data with the characteristic data ID=A1 for a certain frame image and the number of times “Satoshi” has been correctly recognized using characteristic data with the characteristic data ID=A2 for another frame image are “500”.

It should be noted that the number of recognitions represented by the recognition result statistical information in FIG. 4 will be described later again in detail when a process to update the recognition result statistical information in FIG. 4 is described.

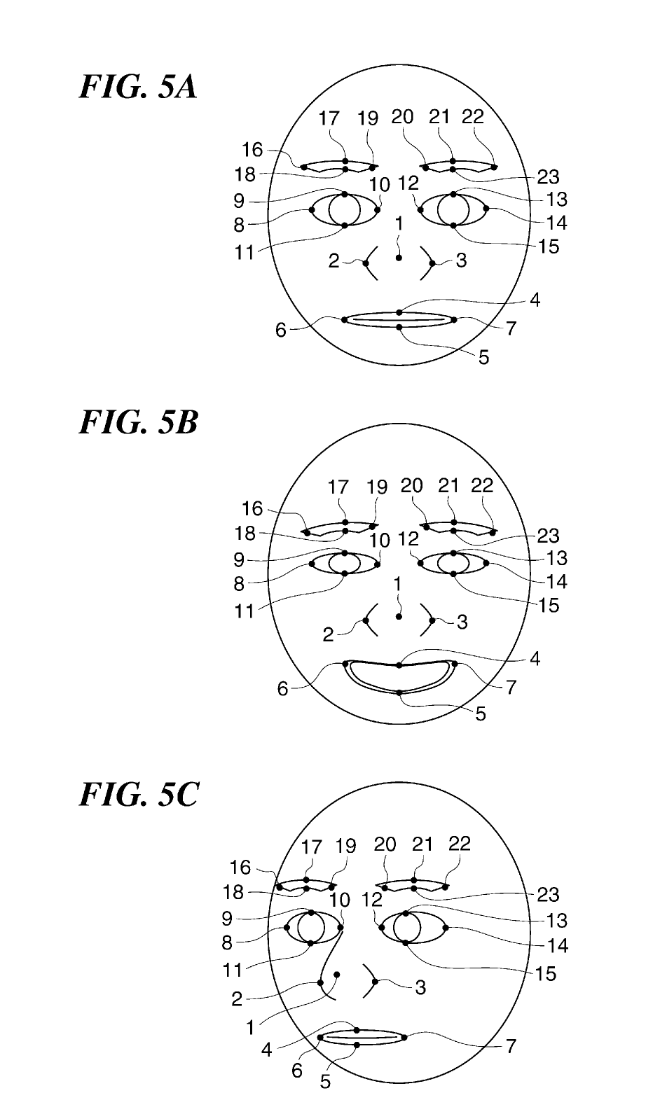

FIGS. 5A to 5C are views showing concrete examples of characteristic data for personal recognition. For the sake of simplification, the following description uses coordinates at 23 characteristic points, but actually, more characteristic points are used to perform personal recognition. The coordinates at 23 characteristic points in FIG. 5A are calculated using normalized face image data based on a position of an edge point of a nose.

The recognition unit 106 assumes coordinates at respective characteristic points, which are calculated from input image data, as Pi (i=1, 2, . . . , 23) and obtains an absolute value sum S=Σ|Pi−P′i| of differences from coordinates P′i at characteristic points of a person registered in advance in the personal database 108. The smaller the absolute value sum S, the higher the possibility that a person to be detected is the same as the person registered in advance. Thus, when the absolute value sum S for the person who is most likely to be the same person is equal to or smaller than a threshold value (recognition threshold value) set in advance, the recognition unit 106 determines that the person to be detected is the same as the person registered in advance, and when the absolute value sum S is greater than the recognition threshold value, the recognition unit 106 determines that there is no corresponding person.

It should be noted that the method that obtains the absolute value sum S is merely an example of methods to perform personal recognition, and personal recognition may be performed using other methods. For example, individuals can be identified based on patterns of changes in the positions and shapes of the eyes and the mouth when facial expressions change, or a final recognition result may be obtained in a comprehensive manner based on results of comparison and collation among a plurality of characteristic data. Namely, the arrangement has only to be such that collation with characteristic data registered in advance in the personal database 108 is performed, and a person who is most likely to be the same person is determined.

Since in the first embodiment, characteristic points detected from image data are used for personal recognition, coordinates at the characteristic points change when, for example, the facial expression or head pose of a person changes as shown in FIG. 5B or 5C. It is thus considered that the value of the absolute value sum S greatly changes to reduce the accuracy of personal recognition. Also, changes in various shooting conditions such as illuminating conditions and backgrounds affect the accuracy of personal recognition. For this reason, a plurality of characteristic data taken under various conditions with respect to each individual is registered in advance in the personal database 108. As a result, the absolute value sum S can be obtained for each of the characteristic data, and hence even when shooting conditions change, a person can be identified more accurately.

However, when a plurality of characteristic data is registered in advance with respect to each individual, characteristic data very similar to that of another person under specific conditions such as a profile may be registered. If such characteristic data is registered, the correct acceptance rate is expected to be increased, but at the same time, the correct rejection rate (the probability that another person is not falsely recognized) may decrease, and the accuracy of personal recognition as a whole could not be increased.

In the first embodiment, basically, to cope with this problem, in a case where characteristic data that causes false recognition for a particular individual (characteristic data that tends to recognize another person) is registered, and the particular individual can be correctly recognized only with other characteristic data, the characteristic data that causes false recognition is deleted. This will be described in detail below.

FIG. 2 is a flowchart showing an overall process carried out by the personal recognition apparatus 100. The process in FIG. 2 is started when image data is input to the image input unit 101. When the image input unit 101 is an image pickup apparatus, the image data is taken by the image pickup apparatus or read out from a storage medium of the image pickup apparatus. When the image input unit 101 is a personal computer, the image data is read out from a storage medium or obtained via a network. In the personal recognition apparatus 100, image data of moving images is input to the image input unit 101, and personal recognition is performed in succession at intervals of frames corresponding to time periods required for personal recognition.

In step S201, the face detection unit 102 receives image data in one frame of moving images from the image input unit 101 and detects a face region of a person. Then, in step S202, the face detection unit 102 determines whether or not a face has been detected. When one or more faces have been detected (YES in the step S202), the process proceeds to step S203, and when no face has been detected (NO in the step S202), the process proceeds to step S206.

In the step S203, based on the result of face detection by the face detection unit 102, the normalization unit 103 normalizes the face region clipped from the image data to generate face image data. At this time, when a plurality of faces is detected in the step S201, face image data is generated for each of the faces. In step S204, the characteristic data generation unit 104 obtains characteristic data including coordinates at characteristic points as shown in FIGS. 5A to 5C from the face image data normalized in the step S203.

In step S205, the recognition unit 106 compares and collates characteristic data on the face detected in the step S204 with characteristic data registered in the personal database 108 to perform recognition as to whose face is the face detected in the step S201, that is, personal recognition. Here, the recognition unit 106 performs collation with respect to each of individuals and characteristic data registered in the personal database 108, and when absolute value sums S obtained for the respective characteristic data are equal to or smaller than a recognition threshold value, the recognition unit 106 obtains characteristic data of which the absolute value sum S is the smallest as a recognition result.

In the step S206, the tracking unit 105 receives the face detection result obtained by the face detection unit 102 and determines whether or not a face estimated to be the same person based on the central position and size of the face among faces detected in preceding frames is present in the next frame (whether or not a face can be tracked). Specifically, the tracking unit 105 compares faces detected in frames in terms of the central position and the size and estimates that in successive frames, faces of which the sum of changes in the central position and size is the smallest are of the same person. However, when the value of the obtained smallest sum is greater than a threshold value set in advance, the tracking unit 105 determines that they are not the same person.

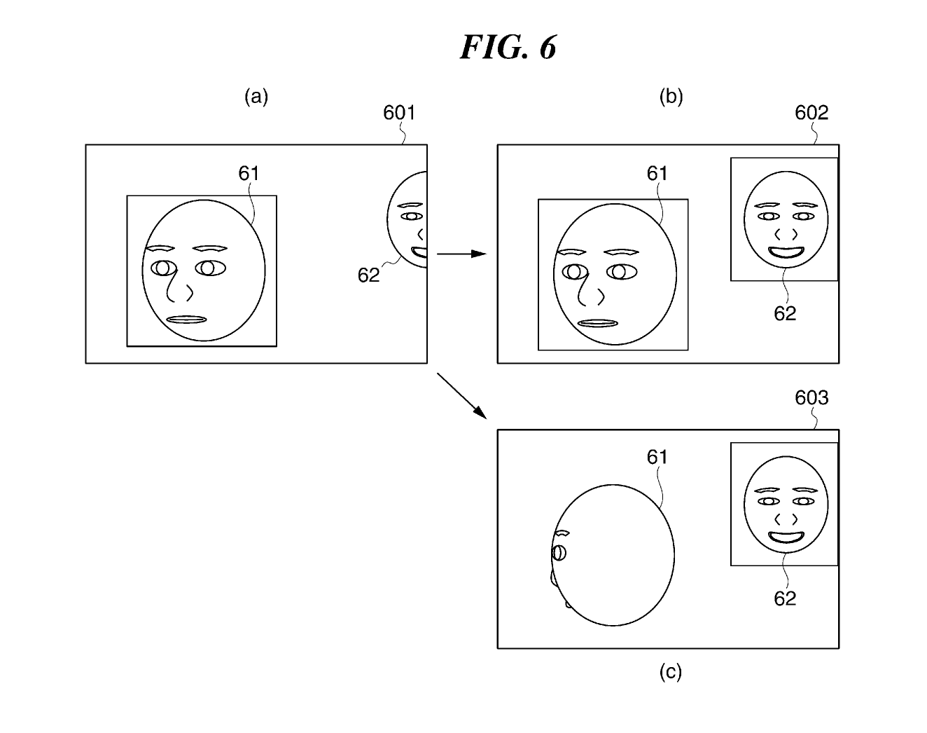

FIG. 6 is a schematic diagram useful in explaining the face tracking process in the step S206. There is a successive change from a frame image 601 of (a) in FIG. 6 to a frame image 602 of (b) in FIG. 6B, and it is assumed that in the frame image 601, a face region of a person 61 is detected, and in the frame image 602, face regions of the person 61 and a person 62 are detected. In this case, the tracking unit 105 compares the face regions of the person 61 and the person 62 detected in the frame image 602 with the face region of the person 61 detected in the frame image 601. As a result, the tracking unit 105 determines that the face region of the person 61 in the frame image 602 and the face region of the person 61 in the frame image 601, which are nearly unchanged in face central position and size and for which the obtained sum is equal to or smaller than a threshold value set in advance, are of the same person.

On the other hand, when no face is detected or a face considered to be of the same person is not detected in the step S201, the tracking unit 105 searches for a peripheral region similar in brightness and color-difference pattern to face regions detected in preceding frames by the face detecting unit 102.

Specifically, there is a successive change from the frame image 601 of (a) in FIG. 6 to a frame image 603 of (c) in FIG. 6, and it is assumed that in the frame image 601, only the face region of the person 61 is detected, and in the frame image 603, only a face region of the person 62 is detected. In this case, the tracking unit 105 compares the face region of the person 62 in the frame image 603 with the face region of the person 61 in the frame image 601. As a result, the tracking unit 105 determines that they are different persons because they both greatly change in face central position and size and the obtained sum is greater than a threshold value set in advance. Based on this determination result, the tracking unit 105 searches the frame image 603 for a peripheral region similar in brightness and color-difference pattern to the face region of the person 61 detected in the frame image 601 and estimates that a face region of the same person is present in a region where the similarity is the highest. However, when the similarity is not equal to or smaller than a threshold value set in advance, the tracking unit 105 determines that there is no same person.

When it is determined that the face was tracked in step S207 (YES in the step S207), the process proceeds to step S210, and when the face was not tracked (NO in the step S207), the process proceeds to step S208. In the step S208, the recognition unit 106 determines whether or not there is a recognition result in the step S205 for the person who was not tracked. There is a recognition result (YES in the step S208), the process proceeds to step S209, and when there is no recognition result (NO in the step S208), the process proceeds to the step S210.

In the step S209, the registration information update unit 107 updates the personal database 108 based on the recognition result. A detailed description will be given later of how the personal database 108 is updated in the step S209. In the step S210, the image input unit 101 determines whether or not in the image data input to the image input unit 101, there is image data in another frame. When there is image data in another frame (YES in the step S210), the process proceeds to step S211, and when there is no image data in another frame (NO in the step S210), an update of the image data is waited for. In the step S211, the image input unit 101 updates the image data, and after that, the process returns to the step S201. As a result, the face detection unit 102 detects a face for the updated image data.

While a person whose face is detected is being tracked as described above, personal recognition is performed using image data of frame images, and recognition results are held in an accumulated manner. Then, at the time when it becomes impossible to track the person, an update of the personal database 108 is performed using simultaneous recognition information that is a series of previously accumulated recognition results based on image data in a plurality of successive frames.

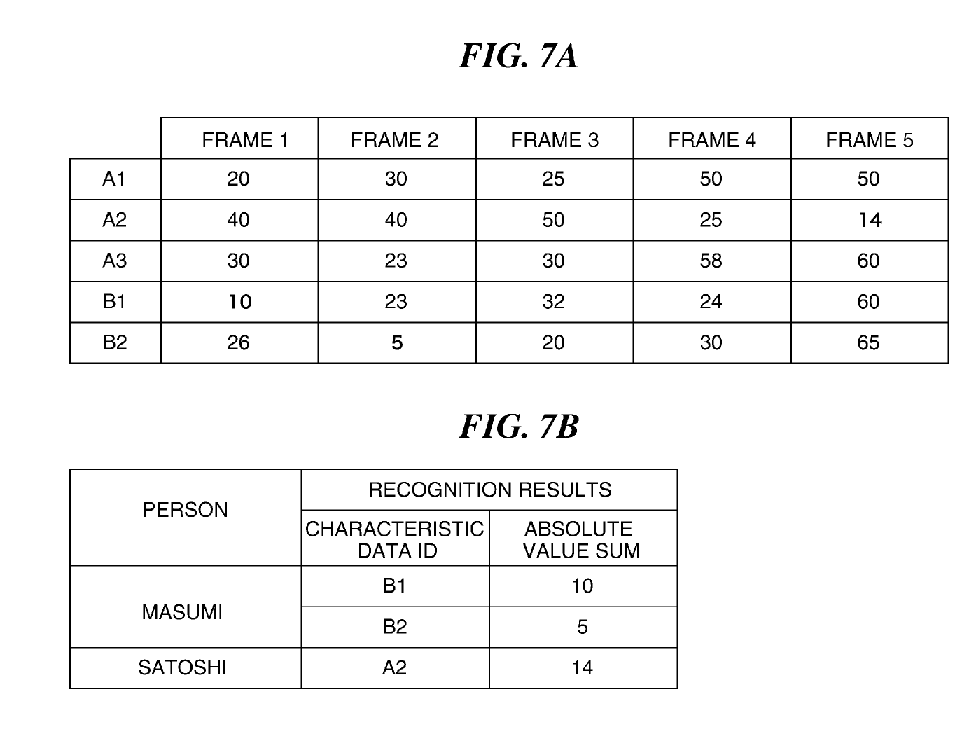

FIG. 7A is a diagram showing results of personal recognition in five successive frames (simultaneous recognition information) in a case where a face of a certain person is detected in those frames. Here, to simplify the explanation, it is assumed that recognition result statistical information on only two persons shown in FIGS. 4A to 4C is stored in the personal database 108. It should be noted that numeric values in FIG. 7A are values of absolute value sums S obtained from changes in coordinates at characteristic points described above with reference to FIGS. 5A to 5C.

Assuming that a recognition threshold value is 15, it is determined that recognition using characteristic data B1 in a frame 1, characteristic data B2 in a frame 2, and characteristic data A2 in a frame 5 is successful. As a result, recognition results of persons updated by personal recognition from the frame 1 to the frame 5 are as shown in FIG. 7B. Based on the recognition results for the persons in FIG. 7B, the personal database 108 (the recognition result statistical information in FIG. 4A) is updated.

Referring now to FIGS. 3 and 4A to 4C, a detailed description will be given of how the personal database 108 is updated in the step S209. FIG. 3 is a flowchart showing the update process for the personal database 108. FIGS. 4B and 4C are views showing results of the update process in the step S209 performed for the recognition result statistical information in FIG. 4A in the personal database 108 based on the recognition results in FIGS. 7A and 7B.

In the update process for the personal database 108, generally, the registration information update unit 107 updates the number of recognitions and the number of mistakes with respect to characteristic data recognized based on recognition results in a plurality of accumulated successive frames. On this occasion, when there is characteristic data of which the number of mistakes is not less than a first threshold value determined in advance and the number of combined recognitions is not less than a second threshold value determined in advance, the registration information update unit 107 deletes this characteristic data.

Namely, in step S301, the registration information update unit 107 determines whether or not a plurality of recognition results is accumulated. When the registration information update unit 107 determines that there is a plurality of recognition results (YES in the step S301), the process proceeds to step S302, and when the registration information update unit 107 determines that there is one recognition result (NO in the step S301), the process proceeds to step S304.

In the step S302, the registration information update unit 107 determines that a person with a personal ID having characteristic data of which the absolute value sum S is the smallest among the plurality of recognition results is a person who has been correctly recognized (hereafter referred to as “the fixed person”). According to the results in FIGS. 7A and 7B, the minimum value of the absolute value sums S is 5, and an ID of characteristic data of which the absolute value sum S is 5 is B2, and hence based on the recognition result statistical information in FIG. 4A, it is determined that the fixed person is “Masumi” whose personal ID is 2.

Then, in step S303, the registration information update unit 107 determines whether or not the fixed person has been recognized using a plurality of characteristic data. When the registration information update unit 107 determines that recognition has been performed using a plurality of characteristic data (YES in the step S303), the process proceeds to step S305, and when the registration information update unit 107 determines that recognition has been performed using a single piece of characteristic data (NO in the step S303), the process proceeds to the step S304. When the results are as shown in FIGS. 7A and 7B, the fixed person is recognized using two characteristic data with characteristic data IDs=B1 and B2, and hence the process proceeds to the step S305.

In the step S304, the registration information update unit 107 adds 1 to (increments) the number of single recognitions using characteristic data based on which the fixed person has been recognized. In the step S305, the registration information update unit 107 adds 1 to the number of recognitions using a combination of characteristic data based on which the fixed person has been recognized. When the results are as shown in FIGS. 7A and 7B, the process does not proceed from the step S303 to the step S304, and hence in the examples shown in FIG. 4B as well, the value of the number of single recognitions for “Masumi” (B1, B2=100, 80) is unchanged. On the other hand, as shown in FIG. 4B, the values in the fields of “recognized with B2 as well” for the characteristic data with the characteristic data ID=B1 and the value of “recognized with B2 as well” for the characteristic data with the ID=B2 are updated from “30” to “31”.

It should be noted that if the fixed person is recognized using characteristic data with the ID=B2 (if all the values of the absolute value sums S of characteristic data with the ID=B1 are greater than 15 in FIGS. 7A and 7B), the process will proceed to the step S304. As a result, in the recognition result statistical information in FIG. 4B, the value in the field of “the number of single recognitions” with the characteristic data with the ID=B2 is updated from “80” to “81”, and the values in the field of “recognized with B2 as well” for the characteristic data with the ID=B1 and “recognized with B1 as well” for the characteristic data with the ID=B2 are unchanged at “30”.

After the steps S304 and S305, the process proceeds to step S306. In the step S306, the registration information update unit 107 assumes a person with a recognized personal ID other than the fixed person as a person who has been falsely recognized and determines whether or not there is any person who has been falsely recognized. When the registration information update unit 107 determines that there is any person who has been falsely recognized (YES in the step S306), the process proceeds to step S307, and when the registration information update unit 107 determines that there is no person who has been falsely recognized person (NO in the step S306), the present process is terminated.

In the step S307, the registration information update unit 107 adds 1 to the number of mistakes relating to a characteristic data ID of the falsely-recognized person in the recognition result statistical information. When the results are as shown in FIGS. 7A and 7B, false recognition is performed using characteristic data with the characteristic data ID=A2, and hence the value “599” in the field of “the number of mistakes” for the characteristic data ID=A2 in FIG. 4A is updated to “600” as shown in FIG. 4B.

In step S308, the registration information update unit 107 determines whether or not there is any characteristic data ID having a value not less than a false recognition threshold value (first threshold value) as the number of mistakes in the recognition result statistical information. The false recognition threshold value is a threshold value for determining whether or not characteristic data frequently causes false recognition. When the registration information update unit 107 determines that there is any characteristic data ID having a value not less than the false recognition threshold value as the number of mistakes (YES in the step S308), the process proceeds to step S309, and when the registration information update unit 107 determines that there is no characteristic data ID having a value not less than the false recognition threshold value as the number of mistakes (NO in the step S308), the present process is terminated.

In the step S309, the registration information update unit 107 determines whether or not the sum of the number of recognitions using combinations of characteristic data IDs is equal to or greater than a plural recognition threshold value (second threshold value). The plural recognition threshold value is a threshold value for use in determining whether or not recognition is frequently performed using characteristic data other than concerned characteristic data. For example, in the case of the characteristic data ID=A2 in FIG. 2A, the sum of the number of recognitions using combinations of characteristic data IDs is 1100 which is the sum of 500 for “recognized with A1 as well” and 600 for “recognized with A3 as well”. When the registration information update unit 107 determines that the number of recognitions using combinations is equal to or greater than the plural recognition threshold value (YES in the step S309), the process proceeds to step S310, and when the registration information update unit 107 determines that the number of recognitions using combinations is not equal to or greater than the plural recognition threshold value (NO in the step S309), the present process is terminated.

In the step S310, the registration information update unit 107 deletes characteristic data of which the sum of the number of recognitions using combinations is equal to or greater than the plural recognition threshold value. As a matter of course, the characteristic data deleted here is characteristic data with characteristic data IDs of which the number of mistakes is equal to or greater than the false recognition threshold value. Then, in step S311, when the remaining characteristic data has been used for recognition in combination with the characteristic data deleted in the step S310, the registration information update unit 107 adds the number of times the remaining characteristic data has been used for recognition in combination with the deleted characteristic data to the number of single recognitions and terminates the present process.

Assume that the recognition result statistical information is updated such that data with the characteristic data ID=B2 (data in a row direction) in FIG. 4A is deleted in the step S310 since the false recognition threshold value and the plural recognition threshold value are set at predetermined values. In this case, data in a column direction for “recognized with B2 as well” is also deleted, and 30 times of “recognized with B2 as well” for data with the characteristic data ID=B1 is added to “the number of single recognitions”, and as a result, “the number of single recognitions” is updated to 130.

Also, assume that both the false recognition threshold value, which is the criterion in the step S308, and the plural recognition threshold value, which is the criterion in the step S309, are set at 600. In this case, since the value 599 in the field of “the number of mistakes” for data with the characteristic data ID=A2 in FIG. 4A has been updated to 600 as shown in FIG. 4B in the step S307, the determination result in the step S308 is “YES”, and the process proceeds to the step S309. For data with the characteristic data ID=A2 in FIG. 4B, the sum of the number of recognitions with combinations is 1100, and hence in the step S310, data with the characteristic data ID=A2 (data in a row direction) is deleted as shown in FIG. 4C. At the same time, data in a column direction for “recognized with A2 as well” is also deleted.

Thus, in the first embodiment, when there is characteristic data based on which a number of mistakes are made (characteristic data that causes false recognition) among characteristic data registered in the personal database 108, it is determined whether or not the person can be correctly recognized even if the characteristic data based on which a number of mistakes are made is absent. This is for the following reason. When a plurality of pieces of characteristic data is present and a plurality of personal recognitions is performed for the same person within a predetermined time period, he or she is recognized using some different characteristic data in response to changes in the angle and expression of his or her face. If it is possible to correctly perform recognition using different characteristic data, this means that personal identification can be recognized even if one of characteristic data based on which the plurality of recognitions has been performed is absent.

As described above, in the first embodiment, when there is characteristic data that causes false recognition among characteristic data registered in the personal database 108, and it is possible to perform recognition using other characteristic data, it is determined that the characteristic data that causes false recognition is unnecessary, and it is deleted. This increases the correct rejection rate. Moreover, since the person can be recognized using other characteristic data without the deleted characteristic data, the correct acceptance rate does not decrease. As a result, the accuracy of personal recognition can be improved. It should be noted that instead of a process of deleting characteristic data that causes false recognition, a process of lowering a priority of the characteristic data that causes false recognition. Namely, recognition using the characteristic data that causes false recognition may be performed only when the person is not recognized even if any of other characteristic data for the person is used.

In the first embodiment, the false recognition threshold value is a fixed value. On the other hand, in a second embodiment, the false recognition threshold value is adjusted according to the number of characteristic data registered in the personal database 108. Namely, in a personal recognition apparatus according to the second embodiment, the registration information update unit 107 changes the false recognition threshold value in the step S308 in FIG. 3 according to characteristic data for which falsely-recognized persons are registered. The setting of the false recognition threshold value is changed by, for example, the recognition unit 106. It should be noted that in other respects, the personal recognition apparatus according to the second embodiment has the same arrangement as that of the personal recognition apparatus 100 according to the first embodiment, and therefore, description thereof is omitted.

In the second embodiment, with respect to each individual, the false recognition threshold value is increased as the number of registered characteristic data decreases. In the first embodiment, with consideration given to the balance between the correct acceptance rate and the correct rejection rate, characteristic data determined to be unnecessary is deleted, but the deletion of characteristic data inevitably decreases the number of times an individual is recognized as genuine.

Thus, when the number of characteristic data (the number of characteristic data IDs) is small, a large false recognition threshold value is set to make deletion of characteristic data difficult for the purpose of securing a certain number of recognitions. Namely, by increasing the false recognition threshold value, the priority with which characteristic data is deleted is lowered. Conversely, when there is a number of characteristic data, it is considered that a sufficient number of recognitions can be secured even if one of characteristic data is deleted. Therefore, the false recognition threshold value is set at a small value so that unnecessary characteristic data can be positively deleted so as to increase the accuracy of personal recognition. Namely, it is possible to correctly recognize the person using other characteristic data, and hence the priority witch which unnecessary characteristic data is deleted is increased.

Thus, in the second embodiment, the criterion by which to determine whether or not to delete characteristic data determined to be unnecessary is adjusted according to the number of characteristic data registered in the personal database 108 with respect to each individual. As a result, the correct rejection rate can be increased as with the first embodiment while the number of times the person is recognized is maintained at a certain level. Moreover, even without deleted characteristic data, recognition can be performed using other characteristic data, a decrease in the correct acceptance rate can be prevented.

In the first embodiment, no consideration is given to the number of single recognitions at the time of deleting characteristic data. On the other hand, in a third embodiment, consideration is given to the number of single recognitions, and characteristic data for which the number of single recognitions is large is prevented from being deleted even when the number of mistakes is large. Namely, in a personal recognition apparatus according to the third embodiment, at the time of determining whether or not to delete characteristic data for which the number of mistakes is equal to or greater than the false recognition threshold value and the total number of recognitions using combinations is equal to or greater than the plural recognition threshold value (the step S309 in FIG. 3), the registration information update unit 107 gives consideration to the number of single recognitions for the characteristic data. It should be noted that in other respects, the personal recognition apparatus according to the third embodiment has the same arrangement as that of the personal recognition apparatus 100 according to the first embodiment, and therefore, description thereof is omitted.

In the third embodiment, even when for characteristic data, the number of mistakes is equal to or greater than the false recognition threshold value and the total number of recognitions using combinations is equal to or greater than the plural recognition threshold value, the characteristic data is not deleted when the number of single recognitions for the characteristic data is equal to or greater than a third threshold value set in advance. This is because if characteristic data for which the number of single recognitions is large is deleted, recognition in many scenes where recognition has not been performed without this characteristic data will become impossible in the future. Thus, in order to ensure the certain accuracy of personal recognition in various scenes as well, it is preferred that characteristic data for which the number of single recognitions is large is not deleted. It should be noted that the setting on a predetermined number of times which is a criterion by which to determine whether or not to delete characteristic data should be varied according to situations so as to ensure the accuracy of personal recognition.

As described above, in the third embodiment, when the number of single recognitions is large, that is, the number of times recognition has been successful unless certain characteristic data is used, this characteristic data is not deleted. As a result, the number of recognitions in personal recognition in various scenes can be maintained at a certain level to prevent a decrease in the correct rejection rate. On the other hand, as with the first embodiment, even when characteristic data is determined to be unnecessary and is deleted, the same person can be recognized using other characteristic data, and hence the correct acceptance rate does not decrease.

In a fourth embodiment, based on recognition result statistical information, the registration information update unit 107 determines whether or not characteristic data has caused many false recognitions, and provides, as recommended registration information, the same characteristic data as characteristic data for which the number of mistakes is equal to or greater than a fourth threshold value so that it can be registered as characteristic data for an individual who has not been recognized. Here, the false recognition threshold value in the first embodiment described above can be used as the fourth threshold value. It should be noted that a personal recognition apparatus according to the fourth embodiment differs from the personal recognition apparatus 100 according to the first embodiment only in terms of functions of the registration information update unit 107, and in other respects, the personal recognition apparatus according to the fourth embodiment has the same arrangement as that of the personal recognition apparatus 100 according to the first embodiment, and therefore, description of the same arrangement is omitted.

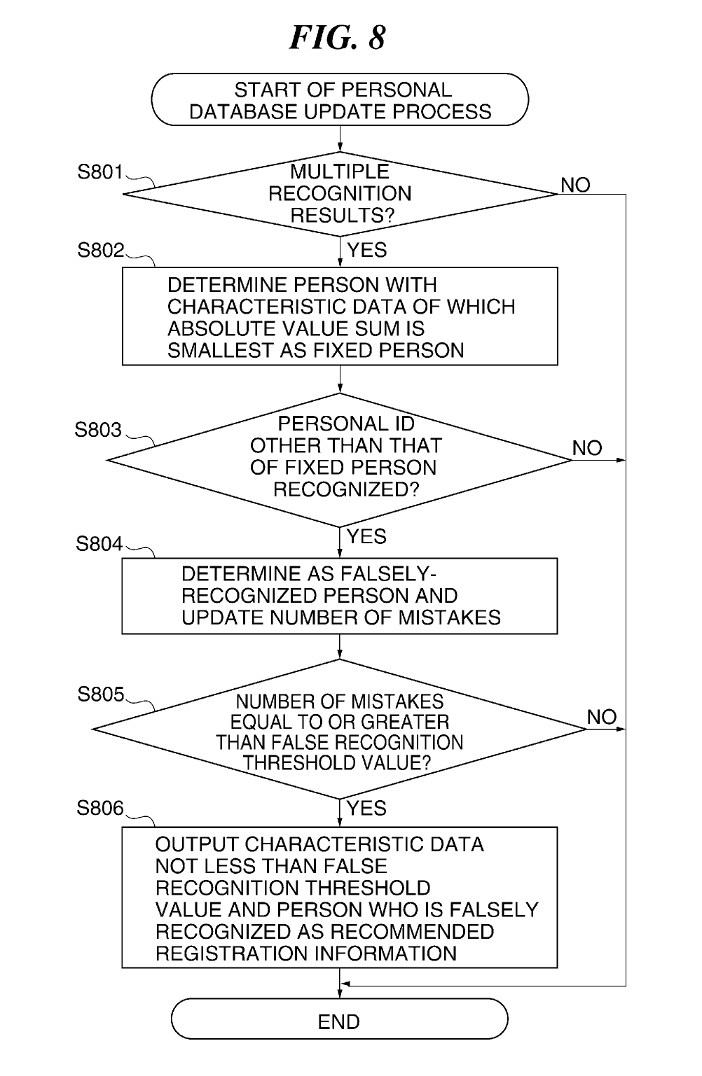

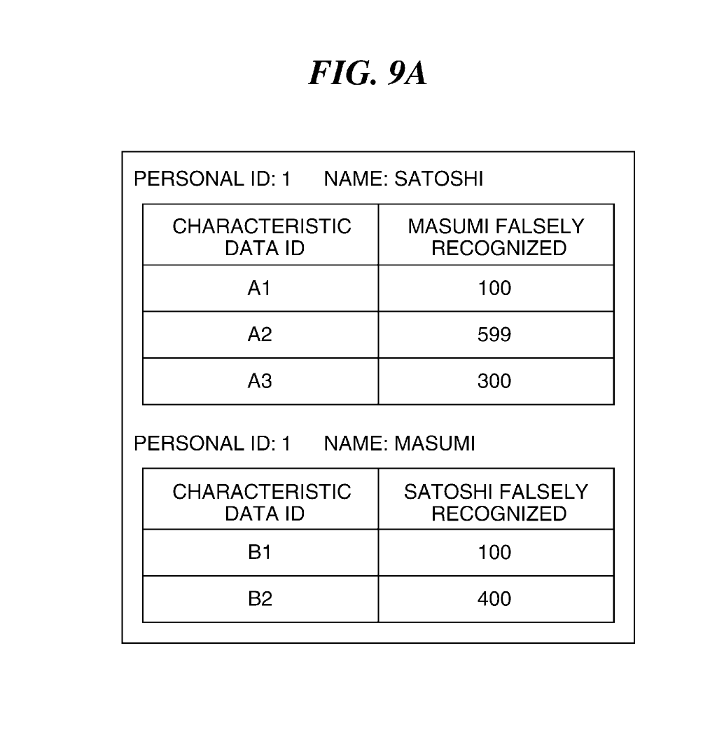

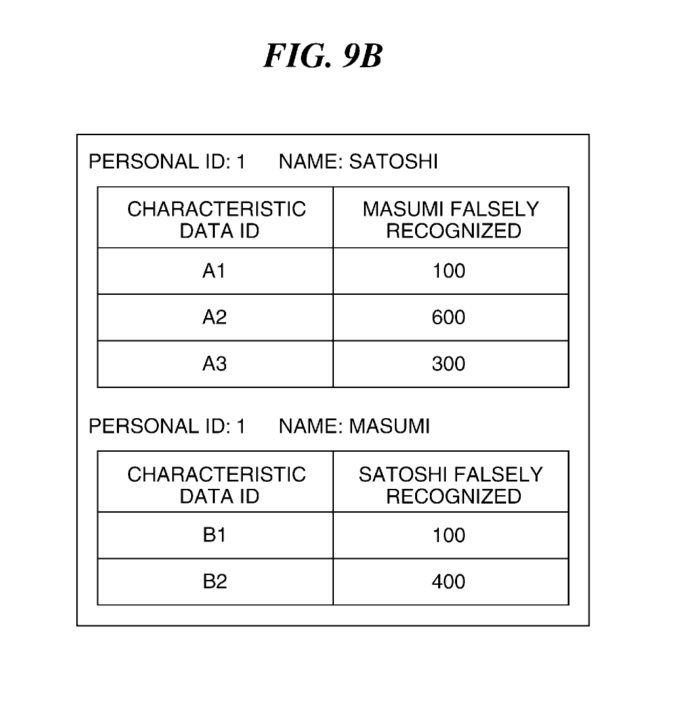

The flow of a personal recognition process carried out by the personal recognition apparatus according to the fourth embodiment will be described with reference to FIG. 8, but before that, referring to FIGS. 9A and 9B, a description will be given of false recognition history information for personal recognition registered in the personal database 108 according to the fourth embodiment.

FIG. 9A is a view showing exemplary false recognition history information prepared to implement the fourth embodiment and shows data before update in step S804, to be described later. The false recognition history information is stored in the personal database 108 with respect to each individual. It should be noted that providing recommended registration information which characterizes personal recognition, in the fourth embodiment requires only the false recognition history information in FIGS. 9A and 9B and does not require the recognition result statistical information in FIGS. 4A to 4C. For this reason, here, the false recognition history information in FIGS. 9A and 9B does not correspond to the recognition result statistical information in FIGS. 4A to 4C.

The false recognition history information is stored so that which other persons are related to the number of mistakes made in previous recognition using characteristic data having respective characteristic data IDs can be made clear. For this reason, in the false recognition history information, which individual has been falsely recognized is stored with respect to each characteristic data ID.

The flow of the overall process carried out by the personal recognition apparatus according to the fourth embodiment is the same as the flow of the process shown in the flowchart of FIG. 2. The fourth embodiment, however, differs from the first embodiment in terms of processes in steps S206 and S209. Only these processes different from those in the first embodiment will be described below.

In step S206 according to the fourth embodiment, the process in the step S206 according to the first embodiment is carried out, and in addition, while a person is being tracked as an identical person, recognition results for this person in respective frames are accumulated and held.

In step S209 according to the fourth embodiment, the personal database 108 is updated based on the accumulated recognition results. FIG. 8 is a flowchart showing in detail an update process for the personal database 108, which is carried out in the step S209 according to the fourth embodiment. Basically, based on the accumulated recognition results in a plurality of successive frames (see FIGS. 7A and 7B), the registration information update unit 107 updates recognition result statistical information on recognized characteristic data. When the number of mistakes is equal to or greater than a threshold value set in advance, recommended registration information is updated. Here, the recommended registration information shows a person for whom it is determined that characteristic data should be additionally registered in the personal database 108 (person to be added), and what type of characteristic data (recommended characteristic data) should be added.

Namely, in step S801, the registration information update unit 107 determines whether or not there is a plurality of accumulated recognition results. when the registration information update unit 107 determines that there is a plurality of accumulated recognition results (YES in the step S801), the process proceeds to step S802, and when the registration information update unit 107 determines that there is only one recognition result (NO in the step S801), the present process is terminated.

In the step S802, the registration information update unit 107 determines that among the plurality of recognition results, a person with a personal ID who has characteristic data for which the absolute value sum S is the smallest is a person who has been correctly recognized (fixed person). Then, in step S803, the registration information update unit 107 determines whether or not there is any personal ID other than that of the fixed person, that is, whether or not there is any person who has been falsely recognized (person having a recognized personal ID other than the fixed person). When the registration information update unit 107 determines that there is any person who has been falsely recognized (YES in the step S803), the process proceeds to step S804, and when the registration information update unit 107 determines that there is no person who has been falsely recognized (NO in the step S803), the present process is terminated.

In the step S804, for the falsely-recognized person in the false recognition history information, the registration information update unit 107 adds 1 to the number of times in the field of the characteristic data ID that the fixed person has been falsely recognized. FIG. 9B is a view showing an exemplary result obtained by updating the false recognition history information in FIG. 9A in the step S804. For example, when the recognition result in FIG. 7B is obtained based on the result in FIG. 7A, the fixed person is “Masumi” having the characteristic data ID=B2 for which the absolute value sum S is smallest, and the falsely-recognized person is “Satoshi” having the characteristic data ID=A2. In this case, the number of times “Masumi has been falsely recognized” for the characteristic data ID=A2 of “Satoshi” in the false recognition history information in FIG. 9A is updated 599 to 600 by adding 1 as shown in FIG. 9B.

Then, in step S805, the registration information update unit 107 determines whether or not there is any characteristic data ID for which the number of mistakes in the false recognition history information is equal to or greater than the false recognition threshold value. When the registration information update unit 107 determines that there is any characteristic data ID for which the number of mistakes is equal to or greater than the false recognition threshold value (YES in the step S805), the process proceeds to step S806, and when the registration information update unit 107 determines that there is no characteristic data ID for which the number of mistakes is equal to or greater than the false recognition threshold value (NO in the step S805), the present process is terminated.

In the step S806, the registration information update unit 107 outputs the characteristic data, for which the number of mistakes is equal to or greater than the false recognition threshold value, as recommended characteristic data. At the same time, the registration information update unit 107 outputs recommended registration information to recommend a person who is falsely recognized (for example, like a fixed person, a person who is not a person having characteristic data for which the number of mistakes is equal to or greater than the false recognition threshold value but is falsely recognized as this person having the characteristic data) as a person to be added. In the false recognition history information in the FIG. 9B after the process in the step S804, assuming that the false recognition threshold value is 600, characteristic data with a characteristic data ID=A2 which is greater than the false recognition threshold value is recommended characteristic data. Moreover, “Masumi” who is falsely recognized as “Satoshi” although she is not “Satoshi” with the characteristic data ID=A2 is a person to be added. After the process in the step S806, the present process is terminated.

As described above, in the fourth embodiment, when there is any characteristic data that has caused many mistakes and causes false recognition among characteristic data registered in the personal database 108, this characteristic data is recommended characteristic data, and recommended registration information indicative of a person who is falsely recognized using this characteristic data as a person to be added is output. The reason why this arrangement is adopted is described below.

One of factors that cause false recognition is that nothing similar in characteristics to characteristic data that causes false recognition is registered for a person who is falsely recognized. In the example shown in FIGS. 9A and 9B, no characteristic data corresponding to the characteristic data ID=A2 is registered for “Masumi”, and this results in recognition of “Satoshi” using characteristic data with the characteristic data ID=A2. Namely, when a person to be recognized is shot with a face pattern that is not registered in the personal database 108 and personal recognition is performed, he or she may be recognized as another person for whom characteristic data of the taken face pattern is registered.

Thus, if characteristic data similar to characteristic data registered for another person who tends to be falsely recognized is additionally registered as characteristic data on a person to be recognized, false recognitions will be reduced, so that the person to be recognized can be correctly recognized, and the accuracy of personal recognition can be improved. Accordingly, in the fourth embodiment, recommended registration information is output, and a user is prompted to register characteristic data represented by the recommended registration information.

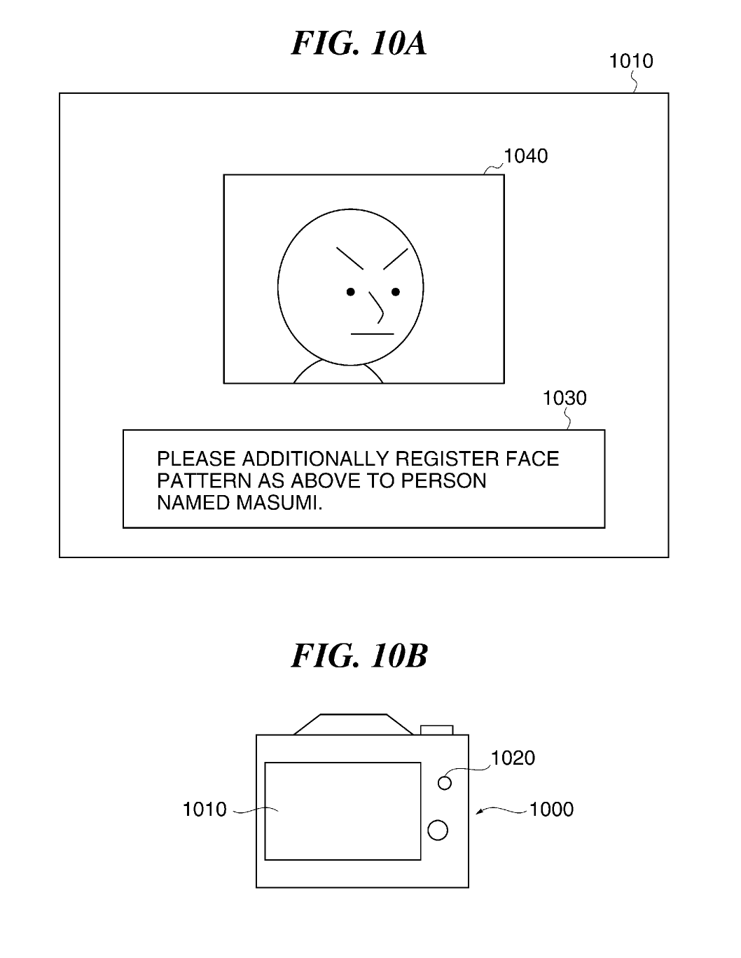

FIG. 10A is a view showing an exemplary view that prompts a user to additionally register characteristic data in the personal database 108 in the step 806. FIG. 10B is a rear view showing an image pickup apparatus 1000 which is an exemplary personal recognition apparatus according to the fourth embodiment.

Here, an image or a directive for the user is displayed on a display panel unit 1010 which the image pickup apparatus 1000 has. A control unit, not shown, which the image pickup apparatus 1000 has carries out a process to display recognition results output from the recognition unit 106, recommended registration information output from the registration information update unit 107, and so forth on the display panel unit 1010. The image pickup apparatus 1000 has a mode switching button 1020 for switching between a shooting mode and a reproduction mode, and whenever the mode switching button 1020 is depressed, the control unit switches modes. A storage device such as a semiconductor memory, not shown, which the image pickup apparatus 1000 has is used as the personal database 108.

The control unit of the image pickup apparatus 1000 holds recommended registration information, and at the time when the image pickup apparatus 1000 shifts into the reproduction mode through user's operation, a panel that prompts the user to additionally register characteristic data (a face image with a predetermined pattern) is displayed based on the recommended registration information. For example, a directive 1030 that prompts the user to additionally register a face image as characteristic data on “Masumi” who is a person to be added is displayed on the display panel unit 1010. On this occasion, in order to show the user what type of face pattern of a face image should be registered, a face image of “Satoshi” with the characteristic data ID=A2 is displayed as a reference image 1040 with the directive 1030 in accordance with recommended characteristic data.

When the user shifts the image pickup apparatus 1000 into the shooting mode and takes a shot so as to take an image to be additionally registered in accordance with this display, for example, characteristic data is extracted from the taken image and automatically added as characteristic data with a characteristic data ID=B3 to false recognition history information on “Masumi” (FIGS. 9A and 9B). It should be noted that when there is recognition result statistical information shown in FIGS. 4A to 4C, the characteristic data with the characteristic data ID=B3 and a recognition result based on it are additionally registered in the recognition result statistical information as well.

At this time, an inquiry may be made of the user about whether or not to additionally register the image taken by the image pickup apparatus 1000, and depending on the inquiry result, a subsequent process may be carried out. Moreover, to deal with a situation where additional registration is not performed immediately after displaying, the image pickup apparatus 1000 may be configured to display recommended registration information again on the display panel unit 1010 when “Masumi” is recognized as a fixed person after that.

As described above, in the fourth embodiment, when a certain person is falsely recognized as the other person because a predetermined face pattern is not registered for him or her, the predetermined face pattern of the person is additionally registered as characteristic data on the person. This increases the correct rejection rate and also increases the correct acceptance rate, resulting in an improvement in the accuracy of personal recognition.

In a fifth embodiment, a process in which the false recognition threshold value is adjusted with consideration given to the number of times the other person has been falsely recognized is added to the processes in the fourth embodiment. Namely, in a personal recognition apparatus according to the fifth embodiment, the false recognition threshold value in the step S805 in FIG. 8 is varied according to the number of times the other person has been falsely recognized. Specifically, the false recognition threshold value is increased with an increase in the number of times the other person is falsely recognized.

This is based on the assumption that in the fourth embodiment, a fixed person can be recognized with higher accuracy by relative determination as long as characteristic data similar to characteristic data on a falsely-recognized person is additionally registered as characteristic data on the fixed person. However, in a case where a plurality of persons has been falsely recognized with a face pattern that is falsely recognized frequently, this face pattern is not characteristic to begin with, and even if similar face patterns are added to characteristic data on the other person, recognition accuracy is unlikely to be improved. Therefore, by increasing the false recognition threshold value with an increase in the number of times the other person is falsely recognized, face data (characteristic data) unuseful for recognition is prevented from being additionally registered through carelessness.

As described above, in the fourth embodiment, when a certain person is falsely recognized as the other person due to a face pattern that is not registered for the person, it is determined whether or not the face pattern is one useful for personal recognition. The face pattern is additionally registered only when it is determined to be useful, so that the correct acceptance rate can be increased without lowering the correct rejection rate (without causing false recognition as the other person), resulting in an improvement in the accuracy of personal recognition.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-010442, filed Jan. 23, 2014, which is hereby incorporated by reference herein in its entirety.

What is claimed is:

1. A personal recognition apparatus that performs personal recognition using an image, comprising:
a detection unit configured to detect a face region of a person included in a frame image that has been input;
a generation unit configured to generate characteristic data from the face region detected by said detection unit;
a storage unit configured to, for a plurality of persons, hold at least a piece of characteristic data for recognizing a person and a recognition history with respect to each of the characteristic data;
a recognition unit configured to perform personal recognition by comparing the characteristic data generated by said generation unit and the characteristic data stored in said storage unit with each other and identifying a person having the characteristic data generated by said generation unit among the plurality of persons stored in said storage unit; and
an update unit configured to update the recognition history stored in said storage unit based on a result of the personal recognition performed by said recognition unit, and when false recognition causing data that causes false recognition is included in the characteristic data stored in said storage unit with respect to a predetermined individual, and the predetermined individual can be correctly recognized using other characteristic data, delete the false recognition causing data from said storage unit or lower a priority of the false recognition causing data.

2. The personal recognition apparatus according to claim 1, further comprising a tracking unit configured to track a face region of the same person shown by the characteristic data generated by generation unit in a plurality of successive frames, and
wherein said recognition unit accumulates, as simultaneous recognition information, a series of recognition results of the personal recognition performed using the characteristic data generated by said generation unit from the face region tracked by said tracking unit, and
based on the simultaneous recognition information, said update unit updates the characteristic data and the recognition history stored in said storage unit.

3. The personal recognition apparatus according to claim 1, wherein the recognition history includes the number of correct recognitions and the number of mistakes that are false recognitions using the characteristic data stored in said storage unit, and
the number of correct recognitions includes the number of single recognitions in which the personal recognition is successfully performed using a piece of characteristic data among the plurality of characteristic data and the number of combined recognitions in which the personal recognition is successfully performed using a plurality of characteristic data among the plurality of characteristic data.

4. The personal recognition apparatus according to claim 3, wherein the false recognition causing data is characteristic data for which the number of mistakes is equal to or greater than a first threshold value, and
a case where it is possible to correctly recognize the predetermined individual using the other characteristic data means a case where the number of combined recognitions in which characteristic data for which the number of mistakes is equal to or greater than the first threshold value is equal to or greater than a second threshold value.

5. The personal recognition apparatus according to claim 4, further comprising a changing unit configured to change the first threshold value so that the first threshold value increases with a decrease in the number of characteristic data stored in said storage unit with respect to the predetermined individual.

6. The personal recognition apparatus according to claim 4, wherein even when the number of combined recognitions in which characteristic data for which the number of mistakes is equal to or greater than the first threshold value is used is equal to or greater than the second threshold value, said update unit does not delete the characteristic data from said storage unit or does not lower the priority of the false recognition causing data when the number of single recognitions is equal to or greater than a third threshold value.

7. A personal recognition apparatus that performs personal recognition using an image, comprising:
a detection unit configured to detect a face region of a person included in a frame image that has been input;
a generation unit configured to generate characteristic data from the face region detected by said detection unit;
a storage unit configured to, for a plurality of persons, hold at least a piece of characteristic data for recognizing a person and the number of mistakes in which the other person has been falsely recognized with the characteristic data;
a recognition unit configured to perform personal recognition by comparing the characteristic data generated by said generation unit and the characteristic data stored in said storage unit with each other and identifying a person having the characteristic data generated by said generation unit among the plurality of persons stored in said storage unit; and
an update unit configured to update the number of mistakes based on a result of the personal recognition;
a first proposal unit configured to propose additional registration of predetermined characteristic data to the characteristic data stored in said storage unit with respect to a predetermined individual; and
a second proposal unit configured to, when characteristic data with which the number of mistakes is equal to or greater than a fourth threshold value is present in a plurality of pieces of characteristic data stored in said storage unit with respect to the predetermined individual after the number of mistakes is updated by said update unit, propose additional registration of characteristic data similar to the characteristic data for which the number of mistakes is equal to or greater than the fourth threshold value to characteristic data on the other person.

8. The personal recognition apparatus according to claim 7, further comprising a tracking unit configured to track a face region of the same person shown by the characteristic data generated by said generation unit in a plurality of successive frames, and
wherein said recognition unit accumulates, as simultaneous recognition information, a series of recognition results of the personal recognition performed using the characteristic data generated by said generation unit from the face region tracked by said tracking unit, and
based on the simultaneous recognition information, said update unit updates the number of mistakes stored in said storage unit.

9. The personal recognition apparatus according to claim 7, wherein the number of mistakes is stored with respect to each of the characteristic data stored in said storage unit so that which other person has been falsely recognized can be clear.

10. The personal recognition apparatus according to claim 7, further comprising a changing unit configured to change the fourth threshold value so that the fourth threshold value increases with an increase in the number of mistakes stored in said storage unit with respect to the predetermined individual.

11. A personal recognition method implemented by a personal recognition apparatus that has a storage unit and performs personal recognition using an image, comprising:
a detection step of detecting a face region of a person included in a frame image that has been input;
a generation step of generating characteristic data from the face region detected in said detection step;
a recognition step of performing personal recognition by comparing the characteristic data generated in said generation step and the characteristic data stored in the storage unit with respect to a plurality of persons so as to recognize persons with each other and identifying a person having the characteristic data generated in said generation step among the plurality of persons stored in the storage unit; and
an update step of updating a recognition history stored in the storage unit based on a result of the personal recognition performed in said recognition step; and
a changing step of, when false recognition causing data that causes false recognition is included in the characteristic data stored in the storage unit with respect to a predetermined individual, and the predetermined individual can be correctly recognized using other characteristic data, deleting the false recognition causing data from the storage unit or lowering a priority of the false recognition causing data.

12. A personal recognition method implemented by a personal recognition apparatus that has a storage unit and performs personal recognition using an image, comprising:
a detection step of detecting a face region of a person included in a frame image that has been input;
a generation step of generating characteristic data from the face region detected in said detection step;
a recognition step of performing personal recognition by comparing the characteristic data generated in said generation step and the characteristic data stored in the storage unit with respect to a plurality of persons so as to recognize persons with each other and identifying a person having the characteristic data generated in said generation step among the plurality of persons stored in the storage unit;
a storage step of, based on a result of the personal recognition, storing the number of mistakes, in which the other person is falsely recognized with the characteristic data stored in the storage unit, in an accumulated manner; and
a proposal step of, when characteristic data for which the number of mistakes is equal to or greater than a fourth threshold value is present in a plurality of pieces of characteristic data stored in the storage unit with respect to a predetermined individual, proposing additional registration of characteristic data similar to the characteristic data for which the number of mistakes is equal to or greater than the fourth threshold value to characteristic data on the other person.

13. A non-transitory computer-readable storage medium storing a program for causing a computer to implement a personal recognition method for a personal recognition apparatus that has a storage unit and performs personal recognition using an image, the personal recognition method comprising:
a detection step of detecting a face region of a person included in a frame image that has been input;
a generation step of generating characteristic data from the face region detected in the detection step;
a recognition step of performing personal recognition by comparing the characteristic data generated in said generation step and the characteristic data stored in the storage unit with respect to a plurality of persons so as to recognize persons with each other and identifying a person having the characteristic data generated in the generation step among the plurality of persons stored in the storage unit; and
an update step of updating a recognition history stored in the storage unit based on a result of the personal recognition performed in the recognition step; and
a changing step of, when false recognition causing data that causes false recognition is included in the characteristic data stored in the storage unit with respect to a predetermined individual, and the predetermined individual can be correctly recognized using other characteristic data, deleting the false recognition causing data from the storage unit or lowering a priority of the false recognition causing data.

14. A non-transitory computer-readable storage medium storing a program for causing a computer to implement a personal recognition method for a personal recognition apparatus that has a storage unit and performs personal recognition using an image, the personal recognition method comprising:
a detection step of detecting a face region of a person included in a frame image that has been input;
a generation step of generating characteristic data from the face region detected in the detection step;
a recognition step of performing personal recognition by comparing the characteristic data generated in said generation step and the characteristic data stored in the storage unit with respect to a plurality of persons so as to recognize persons with each other and identifying a person having the characteristic data generated in the generation step among the plurality of persons stored in the storage unit;
a storage step of, based on a result of the personal recognition, storing the number of mistakes, in which the other person is falsely recognized with the characteristic data stored in the storage unit, in an accumulated manner; and
a proposal step of, when characteristic data for which the number of mistakes is equal to or greater than a fourth threshold value is present in a plurality of pieces of characteristic data stored in the storage unit with respect to a predetermined individual, proposing additional registration of characteristic data similar to the characteristic data for which the number of mistakes is equal to or greater than the fourth threshold value to characteristic data on the other person.
